(19) United States
(12) Patent Application Publication
(10) Pub. No.: US 2010/0263782 A1
(43) Pub. Date: Oct. 21, 2010

(54) OPTICAL ADHESIVE TAPE FOR LIGHT MANAGEMENT OF KEYBOARDS

(75) Inventor: Marc Husemann, Hamburg (DE)

Correspondence Address: Briscoe, Kurt G.;Norris McLaughlin & Marcus, PA, 875 Third Avenue, 8th Floor, New York, NY, 10022, US

(73) Assignee: tesa SE, Hamburg (DE)

(21) Appl. No.: 12/743,586

(22) PCT Filed: Dec. 3, 2008
(86) PCT No.: PCT/EP2008/066681

§ 371 Date: Jun. 16, 2010

(30) Foreign Application Priority Data
Dec. 4, 2007 (DE) 102007058461.1

(51) Int. Cl. C09J 7/02; B32B 37/12

(52) U.S. Cl. 156/60; 428/354

(57) ABSTRACT

The invention relates to an at least one-sided adhesive tape comprising at least one multi-layer substrate material and at least one layer of an adhesive, characterized by a light transmission of not more than 0.1% and a total light reflection of at least 80% and a diffuse light portion of 30-80%, and the use of such adhesive tapes for taping in the production of keyboards.

The invention relates to single-sided or double-sided pressure-sensitive adhesive tapes (PSA tapes) with multilayer carrier constructions and with light-reflecting properties with a high diffuse light fraction and absorbing properties for the backlighting of keyboards.

PSA tapes in the age of industrialization are widespread processing assistants. Particularly for use in the electronics industry, very exacting requirements are made of PSA tapes. As well as particular adhesion properties, PSA tapes ought also to fulfill optical properties for defined applications.

One area of application is that of keyboards. Keyboards are becoming increasingly complex in form, and are also being backlit for easier use at night. Backlighting allows the number or letter of each key to be clearly identified in the dark.

However, there are also problems associated with this operation. For reasons of cost, the number of light sources ought to be limited. Moreover, for example, a large number of light sources reduce the battery operating time of notebooks, for example.

At the present time, therefore, the search is on for solutions which reduce the number of light sources and enable uniform and homogeneous backlighting with just a few light sources. For this reason, white films are frequently used as light guides (to distribute light). A further problem lies in the minimization of interfering light reflections, which likewise result in nonhomogeneous light diversion and, moreover, reduce the precision of the lit letters or numbers.

Moreover, reflection with a very high direct light fraction on the reflection side results in the appearance of light spots.

For the backlighting of keyboards, therefore, there continues to be a need for PSA tapes which provide improvement in respect of the deficiencies described above, or from which such deficiences are wholly or largely absent.

It is an object of the invention, therefore, to provide single-sided and/or double-sided PSA tapes which exhibit high light absorption, high light reflection and high light diffusion on the light-reflecting side, and which can be used for back-face attachment for the lighting of keyboards.

This object is achieved by means of PSA tapes which, as a result of defined carrier film properties, allow not only high light absorption but also a high diffuse light fraction for the backlighting of the keyboard.

The invention accordingly provides at least single-sided pressure-sensitive adhesive tapes comprising at least one multilayer carrier material and at least one layer of a pressure-sensitive adhesive, characterized by a light transmittance of not more than 0.1%, more particularly less than 0.1%, a total light reflection of at least 80% (DIN 5063 parl 3), and a scattered light fraction of 30% to 80%.

The invention is realised more particularly by single-sided or double-sided pressure-sensitive adhesive tapes which comprise a multilayer carrier material and one or two identical or different layers of pressure-sensitive adhesive, and which have the aforementioned light parameters.

The invention provides more particularly single-sided or double-sided pressure-sensitive adhesive tapes which are composed of a multilayer carrier material and of one or two identical or different pressure-sensitive adhesives, having a light transmittance of less than 0.1% and, according to DIN 5063 part 3, a light reflection in total of more than 80% and a scattered light fraction of 30%-80%.

### BRIEF DESCRIPTION OF THE DRAWINGS

The invention will now be described in greater detail with reference to the drawings, wherein:

FIG. 1 is a schematic diagram depicting the backlighting of a keyboard, and example, one possible application of the PSA tapes of the invention in such keyboard;

FIG. 2 is a schematic depicting the construction of one embodiment of the PSA tape of the invention;

FIG. 3 is a schematic depicting the construction of another embodiment of the PSA tape of the invention;

FIG. 4 is a schematic depicting the construction of another embodiment of the PSA tape of the invention;

FIG. 5 is a schematic depicting the construction of another embodiment of the PSA tape of the invention;

FIG. 6 is a schematic depicting the construction of another embodiment of the PSA tape of the invention;

FIG. 7 is a schematic depicting the construction of another embodiment of the PSA tape of the invention;

FIG. 8 is a schematic depicting the construction of another embodiment of the PSA tape of the invention;

FIG. 9 is a schematic depicting the construction of another embodiment of the PSA tape of the invention;

FIG. 10 is a schematic depicting the construction of another embodiment of the PSA tape of the invention;

FIG. 11 is a schematic depicting the construction of another embodiment of the PSA tape of the invention;

FIG. 12 is a schematic depicting the construction of another embodiment of the PSA tape of the invention; and

FIG. 13 is a schematic depicting the construction of another embodiment of the PSA tape of the invention.

The invention provides, furthermore, for the use of the pressure-sensitve adhesive tapes of the invention for optimizing the backlighting of keys (operating keys), keyboards or keyboard arrays, more particularly those of electronic devices. “Optimizing” in this context refers in particular to the boosting of the light yield of one or more light sources (in this case, more particularly, of LEDs; see remarks below) for the backlighting of the keys, keyboards or keyboard arrays, in other words the boosting of the light emitted in the direction of the keys, keyboards or keyboard arrays with no change in the output of the light sources. For this purpose the PSA tapes of the invention may be used as light guides (also referred to as optical waveguides or light distributors), more particularly by being provided between the keys or the actual key array and the light-emitting diodes. The invention also provides in particular, accordingly, for adhesive bonding in the production of keyboards or keyboard arrays, more particularly those of electronic devices.

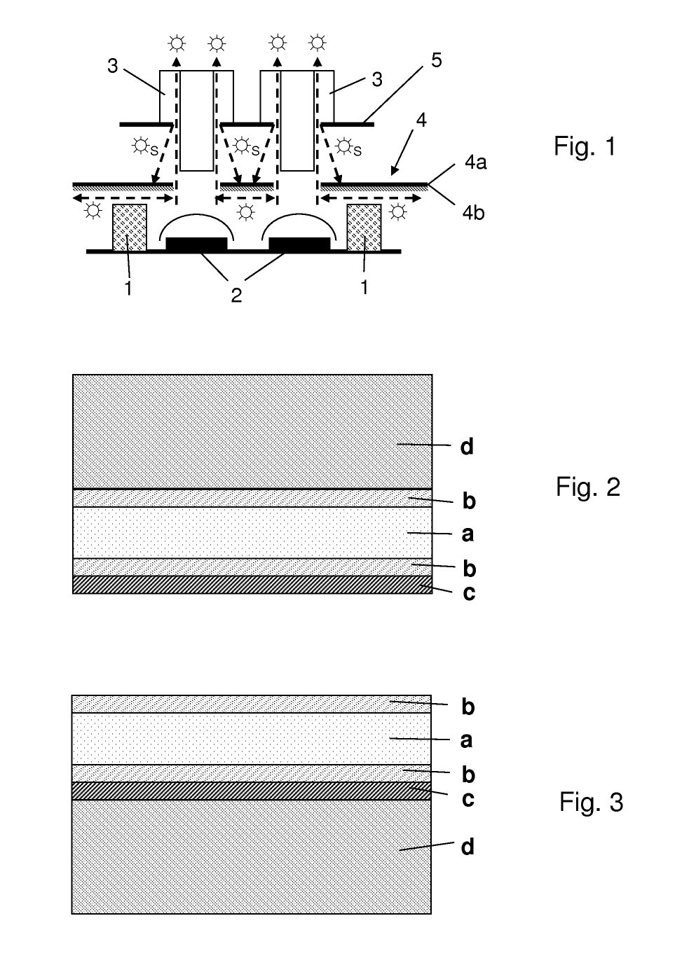

FIG. 1 shows diagrammatically the backlighting of a keyboard of this kind, and reproduces, as an example, one possible application of the PSA tapes of the invention in a keyboard.

The definitions are as follows:
1 LEDs (light-emitting diodes)
2 sensors
3 keys
4 inventive PSA tape
4a light-absorbing side of PSA tape
4b light-reflecting side of PSA tape
5 casing
¤ light
¤s scattered light

The light source used typically comprises LEDs (light-emitting diodes) (1). The LEDs (1) distribute the light (¤) via a light guide (light distributor). This is accomplished preferably with a pressure-sensitve adhesive tape (4) which on one side (4a) is light-absorbing, more particularly black, and on the other side (4b) is light-reflecting, more particularly metallic. The light-reflecting side (4b) preferably faces the side of the LEDs (1), reflects the light, and increases the light yield. The light-absorbing, more particularly black, side (4a) possesses the function of light absorption and advantageously faces the side of the keys (3). Here, scattered light (¤s) is intercepted and the precision of light illumination of the key (3) is increased. The pressure-sensitve adhesives serve for attachment in the keyboard assembly.

The combination of a high reflectance of the light-reflecting, more particularly metallic, side (4b) with a high diffuse light fraction produces a more even illumination of the backlighting unit.

The adhesive tape of the invention advantageously has a light-reflecting side and/or a light-absorbing side.

The adhesive tape of the invention additionally has, particularly for the purpose of light reflection, a metallically reflecting layer, the metallically reflecting layer possibly being responsible solely or supportingly for the reflection, and/or, for the purpose of light absorption, has a color-carrying layer, in other words, more particularly, a layer which has been colored or a layer which is inherently colored. The light-absorbing layer is more particularly a dark layer, preferably a black layer.

In the context of this specification, the metallically reflecting layers of the PSA tapes of the invention, and especially in the embodiments, described below, of FIGS. 2 to 13 as well (in the sense of the light-reflecting layers as described above), may be replaced by white layers (for example, layers which have been colored white), especially when the reflection behavior of the white layers is sufficient for the desired application purpose. Metallic layers, however, have better reflection behavior and are therefore even more suitable for the end use described.

The PSA tapes described in FIG. 1 are described more precisely in their construction in the subsequent figures. They are composed of a multilayer carrier material in each case having one or two PSAs, and they possess a light transmittance of less than 0.1% and, according to DIN 5063 part 3, a light reflection in total of greater than 80% and a scattered light fraction of 30% to 80%.

### Product Constructions

In a first advantageous embodiment according to FIG. 2, the PSA tape of the invention is composed of a carrier film layer (a), two metallically reflecting layers (b), a color-bearing layer (c), and a PSA layer (d) on the light-reflecting side (b).

In another advantageous embodiment according to FIG. 3, the PSA tape of the invention is composed of a carrier film layer (a), two metallically reflecting layers (b), a color-bearing layer (c), and a PSA layer (d) on the color-bearing layer (c).

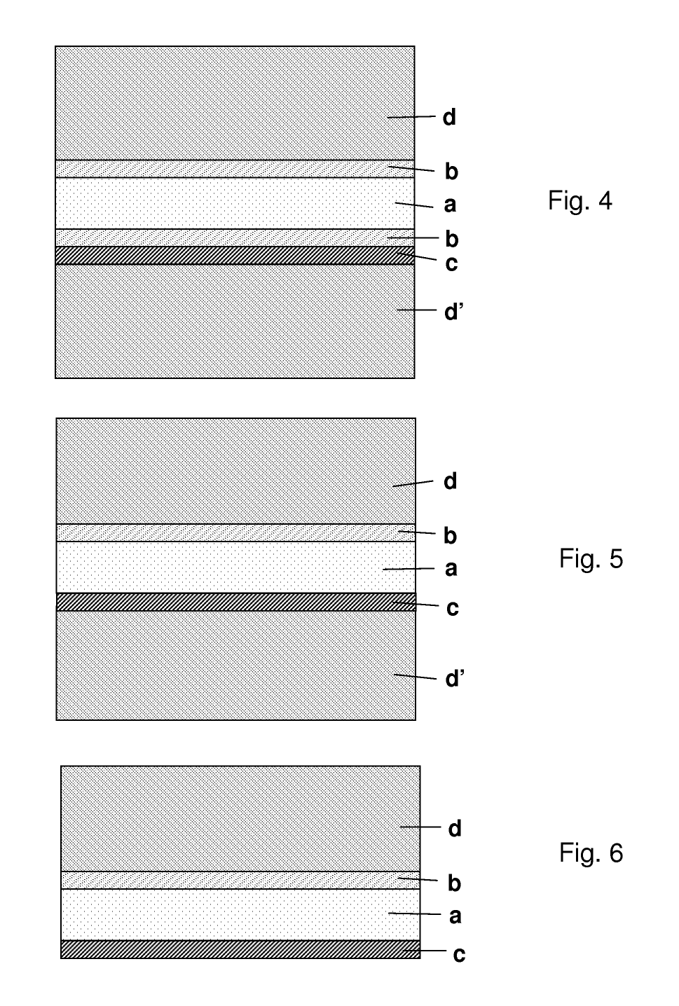

In a further advantageous embodiment according to FIG. 4 the PSA tape of the invention is composed of a carrier film layer (a), two metallically reflecting layers (b), a color-bearing layer (c), and two layers of PSA, (d) and (d′), it being possible for the PSAs (d) and (d′) to be identical or different in composition.

In another preferred embodiment of the invention the PSA tape of the invention possesses the product construction depicted in FIG. 5. In this case the double-sided PSA tape is composed of a carrier film (a), a metallically reflecting layer (b), a color-bearing layer (c), and two pressure-sensitve adhesive layers (d) and (d′), it being possible for the PSAs (d) and (d′) to be identical or to differ from one another.

In a further advantageous embodiment according to FIG. 6 the PSA tape of the invention is composed of a carrier film (a), a metallically reflecting layer (b), a color-bearing layer (c), and a pressure-sensitve adhesive layer (d), the PSA (d) being coated on the reflecting side (b). This embodiment therefore represents a single-sided PSA tape.

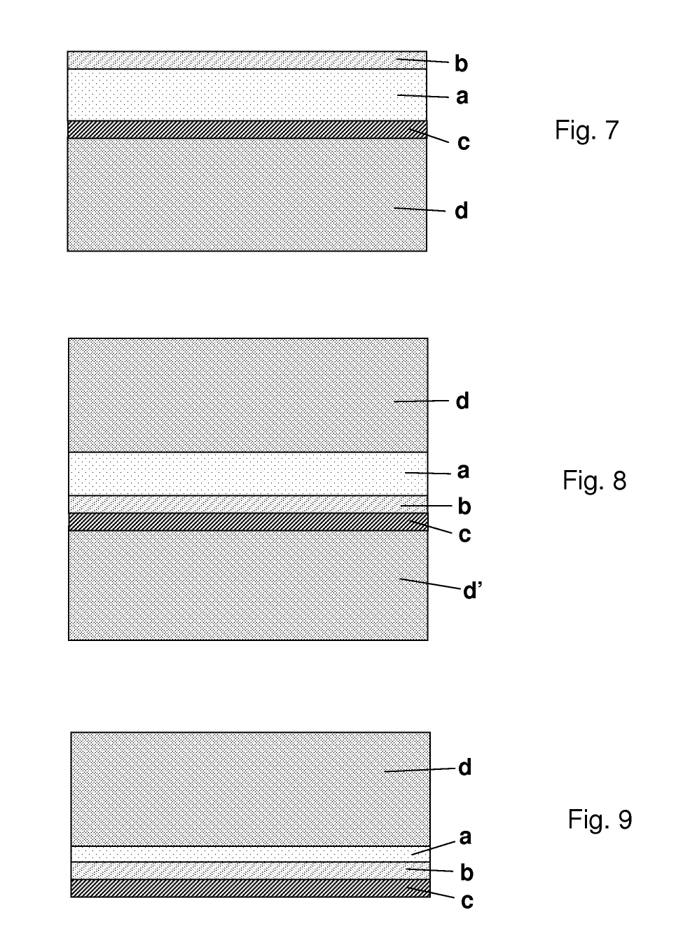

In a further advantageous embodiment according to FIG. 7 the PSA tape—in this case likewise single-sided—is composed of a carrier film (a), a metallically reflecting layer (b), a color-bearing layer (c), and a pressure-sensitve adhesive layer (d), the PSA (d) being coated on the color-bearing layer (c).

In another preferred embodiment of the invention the PSA tape of the invention possesses the product construction shown in FIG. 8; in this case the double-sided PSA tape is composed of a carrier film (a), a metallically reflecting layer (b), a color-bearing layer (c), and two pressure-sensitve adhesive layers (d) and (d′), it being possible for the PSAs to be identical or to differ from one another.

FIG. 9 shows another advantageous embodiment of a single-sided PSA tape of the invention; it is composed of a carrier film (a), a metallically reflecting layer (b), a color-bearing layer (c), and a pressure-sensitve adhesive layer (d), the PSA (d) being applied on the reflecting side (b).

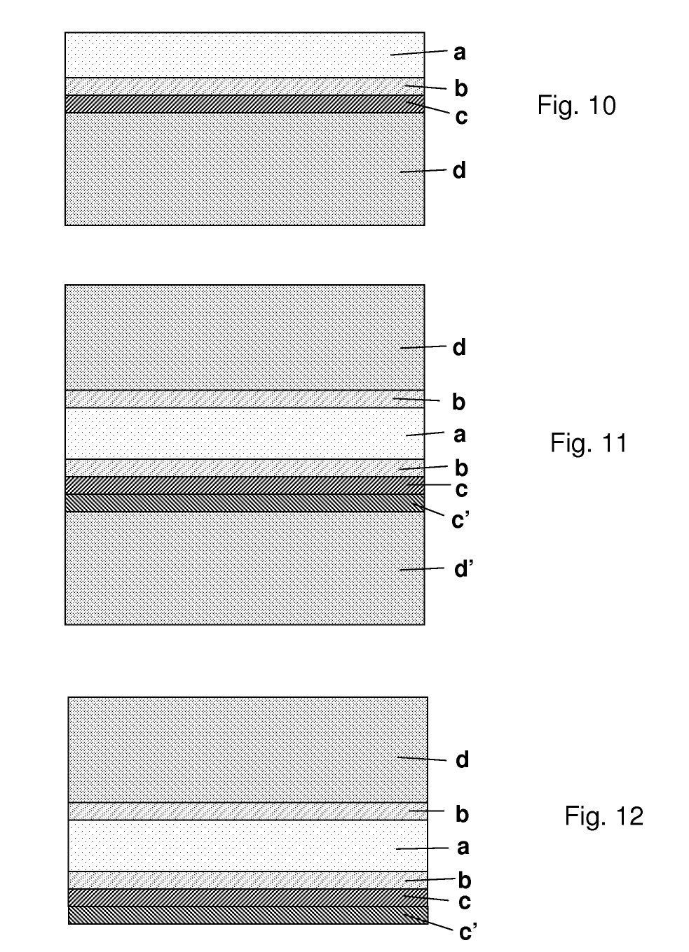

For the embodiment of a single-sided PSA tape of the invention that is advantageous and is shown in FIG. 10, the tape is composed of a carrier film (a), a metallically reflecting layer (b), a color-bearing layer (c), and a pressure-sensitive adhesive layer (d), the PSA (d) being applied on the color-bearing layer (c).

FIG. 11 as well shows an advantageous embodiment of a PSA tape of the invention, which is composed of a carrier film (a), two metallically reflecting layers (b), at least two color-bearing layers (c) and (c′), which are coated one above the other, and two pressure-sensitve adhesives layers (d) and (d′), it being possible for the PSAs to be identical or to differ from one another.

FIG. 12 shows an advantageous embodiment of a single-sided PSA tape of the invention, composed of a carrier film (a), two metallically reflecting layers (b), at least two color-bearing layers (c) and (c′), coated one above the other, and a pressure-sensitve layer (d), the PSA (d) being applied on the reflecting side (b).

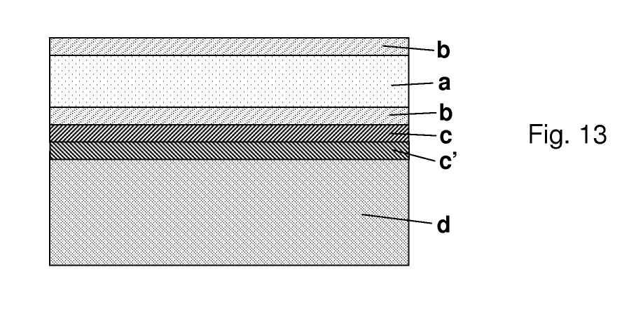

In the case of the advantageous embodiment shown in FIG. 13, the single-sided PSA tape of the invention is composed of a carrier film (a), two metallically reflecting layers (b), at least two color-bearing layers (c) and (c′), which are coated one above the other, and a pressure-sensitve adhesive layer (d), the PSA (d) being applied on the color-bearing layer (c′).

The carrier film (a) is preferably between 5 and 250 μm, more preferably between 8 and 50 μm, very preferably between 12 and 36 μm thick. The carrier film (a) is very preferably transparent, semitransparent or of low light transmittance, as a result, for example, of coloration. In one preferred version of the invention the film (a) is vapor-coated with metal, such as with aluminum or silver, for example, on one or both sides.

The layers (b) are metallically lustrous or slightly matt and light-reflecting. The thickness of the layers (b) is preferably between 5 nm and 200 nm. The layer or layers (c), (c′) are the color-bearing coating layers, each with a thickness preferably of between 0.01 and 5 μm. These layers more particularly guarantee good light absorption behavior of the corresponding adhesive-tape side. One very preferred version uses a black color-bearing layer (c′), accomplished for example through the introduction of black dyes or pigments into the corresponding layer. (c) and (c′) may differ in their chemical natures and may contain different color-bearing pigments, which are advantageous for the light-absorbing properties.

For the color-bearing layers it is also possible to use coating layers, more particularly black coating layers.

The layers (d) and (d′) of PSA preferably possess a thickness of 5 μm to 250 μm in each case. In accordance with the invention, the individual layers (b), (c), (c′), (d), and (d′) may differ in terms of layer thickness within the single-sided or double-sided PSA tape, and so, for example, PSA layers of different thickness may be applied.

### Carrier Film (a)

As film carriers it is possible in principle to use all filmic polymeric carriers. Hence it is possible, for example, to use polyethylene, polypropylene, polyethersulfones, polyamides, polyimides, polyetherimides, polyesters, polyphenylsulfides, polyamidimides, polyetherimides, polymethacrylates, styrene-based films, polycarbonates, polyetherketones, polyaryls, polyurethanes, polyacrylates, polybutyrals, polyethylenvinylacetate, polyethylenenaphthylates, and fluorinated polymers. These types of polymer can be used alone or in combination with one another. In one particularly preferred variant, polyester films are used, more preferably PET films (polyethylene terephthalate).

For the embodiments shown in FIGS. 8 to 10, the carrier film (a) ought to be transparent, and so the corresponding design variants with a transparent carrier film each represent one very preferred inventive embodiment of the respective adhesive tape of the invention.

The films may be in detensioned form or may have one or more preferential directions. Preferential directions are achieved by orientation in one direction or in two directions.

The roughness profile of the carrier film (a) is critical to the inventive properties. Through the film roughness it is possible, after metallization, to control the diffuse fraction of light reflection. Accordingly, very preferably, films having a film roughness Rₐ of greater than 0.05 μm, more preferably of greater than 0.10 and very preferably of greater than 0.15 μm, are used. The preferred maximum film roughness Rₐ is 0.35 μm. The film roughnesses are measured according to DIN 4768 and can be quantified by the Rₐ value. As the film roughness increases, the diffuse light fraction in the light reflection of the metallic side is increased. The roughness Rₐ of the carrier film (a) ought not to exceed 0.35 μm, since otherwise the light reflection becomes too small.

The film roughness of the carrier film (a) can be controlled through the production operation. For instance, in the production operation of the film (a), it is possible to add, for example, antiblocking agents, such as silicon dioxide, siliceous chalk or other chalk, zeolites. Increasing the fraction of antiblocking agent increases the roughness of the film. Furthermore, the films can also be embossed after extrusion. In this case the roughness of the carrier film can be controlled by means of an embossing roll.

Through this production operation it is also possible to make only one of the sides of the film more rough. In one very preferred variant of the invention, then, the rough side is metallized, and is used as a light-reflecting side in the final application.

The extrusion operation can also be used to control film roughness, as well.

At the exit from the lip of the coating die, roughnesses can be generated on the film surface by the lip profile. The surface roughness can also be influenced by controlling the temperature in the coating die. For instance, roughness can be increased by lowering the temperature of the die lip. The absolute temperature profile is dependent on the material extruded (glass transition temperature, rheological profile).

The film roughness can also be controlled by film additives. For example, nanoscale and micrometer scale fillers can be added in order to increase the film roughness.

In one particularly preferred form, the roughness of the film is evenly distributed. In one particularly preferred variant, the roughness has a prismatic structure.

In order to improve the anchorage of the coating layers or of the vapor-deposited metal, it is advantageous to pretreat the films. The films may be etched (trichloroacetic acid or trifluoroacetic acid, for example), pretreated by corona or plasma, or treated with a primer (Saran, for example).

### Reflecting Layer (b)

For producing the light-reflecting and absorbing properties, the film (a) is advantageously vapor-coated on one or both sides with a metal, such as aluminum or silver, for example.

In one very preferred variant of the invention the film layer (a) is vapor-coated on both sides with aluminum or silver. In order to achieve particularly outstanding reflecting properties, the sputtering operation for vapor coating must be controlled in such a way that the aluminum or silver is applied very evenly, in order to obtain optimum reflection. Furthermore, in one very preferred version, a plasma-pretreated film is used and is vapor-coated with aluminum on one or both sides in one workstep. As result of using the reflecting layer (b), first the light is reflected in a targeted way, and second the transmission of the light through the carrier material is reduced. The surface roughness of the film (a) is retained following metallization, albeit in a somewhat attenuated form. The thickness of the metal layer must be completely hiding, i.e., the film (a) must be metallized over its full area.

For the production operation it may be of advantage if the metallized side, prior to being coated with the pressure-sensitive adhesive (PSA), is protected additionally by a transparent varnish.

Color layers (c) and (c′)

The color layers (c) and (c′) may fulfil different functions. In one variant of the invention, the color layer possesses the function of complete absorption of external light. In this case, therefore, the transmittance in a wavelength range from 300 to 800 nm for the double-sided PSA tape must be <0.5%, more preferably <0.1%, very preferably <0.01%. In one preferred variant of the invention this is acheived with a black coating layer. In a curing binder matrix (preferably thermally curing system, although radiation-curing system also possible), black color pigments are mixed into the coating matrix. Coating materials used may be, for example, polyesters, polyurethanes, polyacrylates or polymethacrylates, in conjunction with the coatings additives known to the skilled worker. In one very preferred inventive variant of the invention, carbon black or graphite particles are mixed into the binder matrix, as color-bearing particles. In the case of a very high level of additization (>20% by weight), such additization produces not only complete light absorption but also electrical conductivity, and so the inventive double-sided PSA tapes likewise exhibit antistatic properties.

Furthermore, the layers (c) and (c′) may also possess the additional function of an adhesion prometer. In this case the layer may also improve the adhesion of the PSA (d) or (d′) to the carrier film (a) or to the metallic layer (b), respectively.

To boost the absorbency quality of the black color layer (C), the color layer (c) may additionally be filled with white color pigments. Suitable white color pigments include, preferably, titanium dioxide pigments.

Pressure-Sensitive Adhesives (PSA) (d) and (d′)

In one preferred variant of the invention the PSAs (d) and (d′) are identical on both sides of the PSA tape. In one specific variant of the invention, however, it may also be advantageous for the PSAs (d) and (d′) to differ from one another in layer thickness and/or chemical composition. In this way it is possible, for example, to set different pressure-sensitive adhesion properties. PSA systems used for the inventive double-sided PSA tape are adhesives of acrylate, natural rubber, synthetic rubber, silicone or EVA type. For one inventive variant of the invention, where the double-sided inventive PSA tape is highly reflective on at least one side, it is very advantageous for the PSA at least on that side to have, preferably, a high transparency.

It is also possible in principle, however, to process any other PSAs known to the skilled worker, of the kind that are listed, for example, in the “Handbook of Pressure Sensitive Adhesive Technology” by Donatas Satas (van Nostrand, N.Y. 1989).

For natural rubber adhesives the natural rubber is milled to a molecular weight (weight average) of not below about 100 000 daltons, preferably not below 500 000 daltons, and additized.

In the case of rubber/synthetic rubber as starting material for the adhesive, there are wide possibilities for variation. Use may be made of natural rubbers or of synthetic rubbers, or of any desired blends of natural rubbers and/or synthetic rubbers, it being possible for the natural rubber or natural rubbers to be chosen in principle from all available grades, such as, for example, crepe, RSS, ADS, TSR or CV grades, in accordance with the purity level and viscosity level required, and for the synthetic rubber or synthetic rubbers to be chosen from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends thereof.

With further preference it is possible, in order to improve the processing properties of the rubbers, to add to them thermoplastic elastomers with a weight fraction of 10% to 50% by weight, based on the overall elastomer fraction. As representatives, mention may be made at this point, in particular, of the particularly compatible styrene-isoprene-styrene (SIS) and styrene-butadiene-styrene (SBS) types.

In one inventively preferred variant of the invention it is preferred to use (meth)acrylate PSAs. (Meth)acrylate PSAs for advantageous use in accordance with the invention which are obtainable by free-radical polymerization, consist to the extent of at least 50% by weight of at least one acrylic monomer from the group of the compounds of the following general formula:

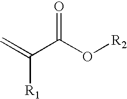

where R₁ is H or CH₃ and the radical R₂ is H or CH₃ or is selected from the group of branched or unbranched, saturated alkyl groups having 1-30 carbon atoms.

The monomers are preferably chosen such that the resulting polymers can be used, at room temperature or higher temperatures, as PSAs, particularly such that the resulting polymers possess pressure-sensitive adhesive properties as per the Handbook of Pressure Sensitive Adhesive Technology of Donatas Satas (fan Nostrand, N.Y. 1989).

In a further inventive variant of the invention the comonomer composition is chosen such that the PSAs can be used as heat-activable PSAs.

The polymers can be obtained preferably by polymerizing a monomer mixture which is composed of acrylic esters and/or methacrylic esters and/or the free acids thereof, with the formula CH₂═C(R₁)(COOR₂), where R₁ is H or CH₃ and R₂ is an alkyl chain having 1-20 C atoms or is H.

The molar masses M_{w} of the polyacrylates used amount preferably to M_{w≧}200 000 g/mol.

In one way which is greatly preferred, acrylic or methacrylic monomers are used which are composed of acrylic and methacrylic esters having alkyl groups comprising 4 to 14 C atoms, and preferably comprise 4 to 9 C atoms. Specific examples, without wishing to be restricted by this enumeration, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and the branched isomers thereof, such as isobutyl acrylate, 2-ethyl-hexyl acrylate, 2-ethylhexyl methacrylate, isooctyl acrylate, and isooctyl methacrylate, for example.

Further classes of compound which can be used are monofunctional acrylates and/or methacrylates of bridged cycloalkyl alcohols consisting of at least 6 C atoms. The cycloalkyl alcohols can also be substituted, by C-1-6 alkyl groups, halogen atoms or cyano groups, for example. Specific examples are cyclohexyl methacrylates, isobornyl acrylate, isobornyl methacrylates, and 3,5-dimethyladamantyl acrylate.

In one procedure monomers are used which carry polar groups such as carboxyl radicals, sulfonic and phosphonic acid, hydroxyl radicals, lactam and lactone, N-substituted amide, N-substituted amine, carbamate, epoxy, thiol, alkoxy or cyano radicals, ethers or the like.

Moderate basic monomers are, for example, N,N-dialkyl-substituted amides, such as, for example, N,N-dimethylacrylamide, N,N-dimethylmethmethacrylamide, N-tert-butylacryl-amide, N-vinylpyrrolidone, N-vinyllactam, dimethylaminoethyl methacrylate, dimethylaminoethyl acrylate, diethylaminoethyl methacrylate, diethylaminoethyl acrylate, N-methylolmethacrylamide, N-(butoxymethyl)methacrylamide, N-methylolacrylamide, N-(ethoxymethyl)acrylamide, N-isopropylacrylamide, this enumeration not being exhaustive.

Further preferred examples are hydroxyethyl acrylate, hydroxyethyl methacrylate, hydroxypropyl methacrylate, allyl alcohol, itaconic anhydride, itaconic acid, glyceridyl methacrylate, 2-butoxyethyl methacrylate, hydroxypropyl acrylate, maleic anhydride, phenoxyethyl acrylate, 2-butoxyethyl acrylate, cyanoethyl methacrylate, cyanoethyl acrylate, glyceryl methacrylate, 6-hydroxyhexyl methacrylate, vinylacetic acid, tetrahydrofurfuryl acrylate, β-acryloyloxypropionic acid, trichloroacrylic acid, fumaric acid, crotonic acid, aconitic acid, and dimethylacrylic acid, this enumeration not being exhaustive.

In one further very preferred procedure use is made as monomers of vinyl esters, vinyl ethers, vinyl halides, vinylidene halides, and vinyl compounds having aromatic rings and heterocycles in α-position. Here again, mention may be made, nonexclusively, of some examples: vinyl acetate, vinylformamide, vinylpyridine, ethyl vinyl ether, vinyl chloride, vinylidene chloride, and acrylonitrile.

Moreover, in a further procedure, use can be made of photoinitiators having a copolymerizable double bond. Suitable photoinitiators include Norrish I and II photoinitiators. Examples include benzoin acrylate and an acrylated benzophenone from UCB (Ebecryl P 36®). In principle it is possible to copolymerize any photoinitiators which are known to the skilled worker and which are able to crosslink the polymer by way of a free-radical mechanism under UV irradiation. An overview of possible photoinitiators which can be used, and which may be functionalized with a double bond, is given in Fouassier: “Photoinitiation, Photopolymerization and Photocuring: Fundamentals and Applications”, Hanser-Verlag, Munich 1995. As a supplement, use is made of Carroy et al. in “Chemistry and Technology of UV and EB Formulation for Coatings, Inks and Paints”. Oldring (Ed.), 1994. SITA. London.

In another preferred procedure the comonomers described are admixed with monomers which possess a high static glass transition temperature. Suitable components include aromatic vinyl compounds, an example being styrene, in which the aromatic nuclei consist preferably of C₄ to C₁₈ units and may also include heteroatoms. Particularly preferred examples are 4-vinylpyridine, N-vinylphthalimide, methylstyrene, 3,4-dimethoxy-styrene, 4-vinylbenzoic acid, benzyl acrylate, benzyl methacrylate, phenyl acrylate, phenyl methacrylate, t-butylphenyl acrylate, t-butylphenyl methacrylate, 4-biphenylyl acrylate, 4-biphenylyl methacrylate, 2-naphthyl acrylate, 2-naphthyl methacrylate, and mixtures of these monomers, this enumeration not being exhaustive.

As a result of the increase in the aromatic fraction there is a rise in the refractive index of the PSA, and the scattering between LCD glass and PSA, as a result, for example, of extraneous light, is minimized.

For further development it is possible to admix resins to the PSAs. As tackifying resins for addition it is possible to use all of the tackifier resins known in the art and described in the literature. Representatives that may be mentioned include pinene resins, indene resins and rosins, their disproportionated, hydrogenated, polymerized, and esterified derivatives and salts, the aliphatic and aromatic hydrocarbon resins, terpene resins and terpene-phenolic resins, and also C5, C9, and other hydrocarbon resins. Any desired combinations of these and further resins may be used in order to adjust the properties of the resultant adhesive in accordance with requirements. Generally speaking it is possible to employ any resins which are compatible (soluble) with the polyacrylate in question: in particular, reference may be made to all aliphatic, aromatic and alkylaromatic hydrocarbon resins, hydrocarbon resins based on single monomers, hydrogenated hydrocarbon resins, functional hydrocarbon resins, and natural resins. Express reference may be made to the representation of the state of the art in the Handbook of Pressure Sensitive Adhesive Technology by Conatas Satas (van Nostrand, 1989).

Here as well, the transparency is improved using, preferably, transparent resins which are highly compatible with the polymer. Hydrogenated or partly hydrogenated resins frequently feature these properties.

In addition it is possible optionally to add plasticizers, further fillers (such as, for example, fibers, carbon black, zinc oxide, chalk, solid or hollow glass beads, microbeads made of other materials, silica, silicates), nucleators, electrically conductive materials, such as, for example, conjugated polymers, doped conjugated polymers, metal pigments, metal particles, metal salts, graphite, etc., expandants, compounding agents and/or aging inhibitors, in the form of, for example, primary and secondary antioxidants or in the form of light stabilizers.

In another possible variant of the invention the PSA (d′), which is supplied on the black layer (c), comprises light-absorbing particles, such as black color pigments or carbon black particles or graphite particles, for example, as a filler.

In addition it is possible to admix crosslinkers and crosslinking promoters. Examples of suitable crosslinkers for electron beam crosslinking and UV crosslinking include difunctional or polyfunctional acrylates, difunctional or polyfunctional isocyanates (including those in blocked form), and difunctional or polyfunctional epoxides. In addition it is also possible for thermally activable crosslinkers to have been added, such as Lewis acid, metal chelates or polyfunctional isocyanates, for example.

For optional crosslinking with UV light it is possible to add UV-absorbing photoinitiators to the PSAs. Useful photoinitiators whose use is very effective are benzoin ethers, such as benzoin methyl ether and benzoin isopropyl ether, substituted acetophenones, such as 2,2-diethoxyacetophenone (available as Irgacure 651® from Ciba Geigy®), 2,2-dimethoxy-2-phenyl-1-phenylethanone, dimethoxyhydroxyacetophenone, substituted α-ketols, such as 2-methoxy-2-hydroxypropiophenone, aromatic sulfonyl chlorides, such as 2-naphthylsulfonyl chloride, and photoactive oximes, such as 1-phenyl-1,2-propanedione 2-(O-ethoxycarbonyl)oxime, for example.

The abovementioned photoinitiators and others which can be used, and also others of the Norrish I or Norrish II type, can contain the following radicals: benzophenone, acetophenone, benzil, benzoin, hydroxyalkylphenone, phenyl cyclohexyl ketone, anthraquinone, trimethylbenzoylphosphine oxide, methylthiophenylmorpholine ketone, aminoketone, azobenzoin, thioxanthone, hexarylbisimidazole, triazine, or fluorenone, it being possible for each of these radicals to be additionally substituted by one or more halogen atoms and/or by one or more alkyloxy groups and/or by one or more amino groups or hydroxy groups. A representative overview is given by Fouassier: “Photoinitiation, Photopolymerization and Photocuring: Fundamentals and Applications”, Hanser-Verlag, Munich 1995. As a supplement, reference may be made to Carroy et al. in “Chemistry and Technology of UV and EB Formulation for Coatings, Inks and Paints”, Oldring (ed.), 1994, SITA, London.

### Coating Method, Equipping of the Carrier Material

In order to produce PSA tapes of the invention, in one preferred procedure the PSA is coated from solution onto the carrier material. To increase the anchoring of the PSA it is possible optionally to pretreat the layers (b) and/or (c) and (c′). Thus pretreatment may be carried out, for example, by corona or by plasma, a primer can be applied from the melt or from solution, or etching may take place chemically.

Particularly in the case of a black coating layer, however, the corona power ought to be minimized, since otherwise pinholes (optical defects, interference sites) are burnt into the film. For the coating of the PSA from solution, heat is supplied, in a drying tunnel for example, to remove the solvent and, if appropriate, initiate the crosslinking reaction.

The polymers described above can also be coated, furthermore, as hotmelt systems (i.e., from the melt). For the preparation process it may therefore be necessary to remove the solvent from the PSA. In this case it is possible in principle to use any of the techniques known to the skilled worker. One very preferred technique is that of concentration using a single-screw or twin-screw extruder. The twin-screw extruder can be operated corotatingly or counterrotatingly. The solvent or water is preferably distilled off over two or more vacuum stages. Counterheating is also carried out depending on the distillation temperature of the solvent. The residual solvent fractions amount to preferably <1%, more preferably <0.5%, and very preferably <0.2%. Further processing of the hotmelt takes place from the melt.

For coating as a hotmelt it is possible to employ different coating processes. In one version the PSAs are coated by a roll coating process. Different roll coating processes are described in the “Handbook of Pressure Sensitive Adhesive Technology”, by Donatas Satas (van Nostrand, N.Y. 1989). In another version, coating takes place via a melt die. In a further preferred process, coating is carried out by extrusion. Extrusion coating is performed preferably using an extrusion die. The extrusion dies used may come advantageously from one of the three following categories: T-dies, fishtail dies and coathanger dies. The individual types differ in the design of their flow channels.

Through the coating it is also possible for the PSAs to undergo orientation.

In addition it may be necessary for the PSA to be crosslinked. In one preferred version, crosslinking takes place with electron and/or UV radiation.

UV crosslinking irradiation is carried out with shortwave ultraviolet irradiation in a wavelength range from 200 to 400 nm, depending on the UV photoinitiator used; in particular, irradiation is carried out using high-pressure or medium-pressure mercury lamps at an output of 80 to 240 W/cm. The irradiation intensity is adapted to the respective quantum yield of the UV photoinitiator and the degree of crosslinking that is to be set.

Furthermore, in one variant of the invention, it is possible to crosslink the PSAs using electron beams. Typical irradiation equipment which can be employed includes linear cathode systems, scanner systems, and segmented cathode systems, where electron beam accelerators are employed. A detailed description of the state of the art and the most important process parameters are found in Skelhorne, Electron Beam Processing, in Chemistry and Technology of UV and EB formulation for Coatings, Inks and Paints, Vol. 1, 1991, SITA, London. The typical acceleration voltages are situated in the range between 50 kV and 500 kV, preferably 80 kV and 300 kV. The scatter doses employed range between 5 to 150 kGy, in particular between 20 and 100 kGy.

It is also possible to employ both crosslinking processes, or other processes allowing high-energy irradiation.

The invention further provides for the use of the single- and double-sided pressure-sensitive adhesive tapes for adhesive bonding of keyboard backlighting units. The adhesive bonding is illustrated in FIG. 1, by way of example. For use as pressure-sensitive adhesive tape it is possible for the single- or double-sided pressure-sensitive adhesive tapes to have been lined with one or two release films or release papers. In one preferred variant of the invention use is made of siliconized or fluorinated films or papers, such as glassine, HDPE or LDPE coated papers, for example, which have in turn been given a release coat based on silicones or fluorinated polymers or fluorinated silicones. The PSA tapes of the invention can be used, accordingly, especially to optimize keyboard backlighting.

### EXAMPLES

The invention is described below, without wishing any unnecessary restriction to result from the choice of the examples.

The test methods below were employed.

### Test Methods

### A. Transmittance

The transmittance was measured in the wavelength range from 190 to 900 nm using a Uvikon 923 from Biotek Kontron. The absolute transmittance is reported in % as the value at 550 nm.

### B. Roughness

The roughness of the film is determined and reported in accordance with DIN 4768. The roughness is reported in the form of the Rₐ value, in μm.

### C. Reflection

The reflection test is carried out in accordance with DIN standard 5063 part 3. The instrument used was a type LMT Ulbrecht sphere. The reflectance is reported and the scattered light fractions are reported in %.

### Polymer 1

A 200 l reactor conventional for free-radical polymerizations was charged with 2400 g of acrylic acid, 64 kg of 2-ethylhexyl acrylate, 6.4 kg of N-isopropylacrylamide and 53.3 kg of acetone/isopropanol (95:5). After nitrogen gas had been passed through the reactor for 45 minutes with stirring, the reactor was heated to 58° C. and 40 g of 2,2′-azoisobutyronitrile (AIBN) were added. Subsequently the external heating bath was heated to 75° C. and the reaction was carried out constantly at this external temperature. After a reaction time of 1 h a further 40 g of AIBN were added. After 5 h and 10 h, dilution was carried out with 15 kg each time of acetone/isopropanol (95:5). After 6 h and 8 h, 100 g each time of dicyclohexyl peroxydicarbonate (Perkadox 16®, Akzo Nobel) in solution in each case in 800 g of acetone were added. The reaction was terminated after a reaction time of 24 h, and the reaction mixture was cooled to room temperature.

### Crosslinking

The PSAs are coated from solution onto a siliconized release paper (PE coated release paper from Loparex), dried in a drying cabinet at 100° C. for 10 minutes, and then crosslinked with a dose of 25 kGy at an acceleration voltage of 200 kV. The coatweight was in each case 50 g/m².

### Films (Al Vapor Coating):

The PET films were vapor-coated on both sides with aluminum until a layer of aluminum had been applied to both sides. The film was vapor-coated in a width of 300 mm by the sputtering method. In this method, positively charged, ionized argon gas is passed into a high-vacuum chamber. The charged ions then impinge on a negatively charged Al plate and, at the molecular level, detach particles of aluminum, which then deposit on the polyester film which is passed over the plate.

### Films (Color Coating):

### Preparation of the Black Ink:

The black ink was prepared from 4 parts of curative CVL No. 10 (from Dainippon Ink and Chemicals, Inc.) and 35 parts of Daireducer™ V No. 20 (from Dainippon Ink and Chemicals, Inc.) and also 100 parts of Panacea™ CVL-SPR805 ink (from Dainippon Ink and Chemicals, Inc.), a vinyl chloride/vinyl acetate based ink.

### Film 1 (Black/Silver):

The black ink is applied over one side of the Al-coated film SO 15 (Basis: SKC Polyester Film SO 15, Rₐ=0.221 μm by test method B) and dried at 45° C. for 48 hours. The side coated with black coating material is completely and uniformly black. The coat weight is approximately 2 g/m².

### Film 2 (Black/Silver):

The white ink is applied over one side of the Al-coated film SC 44 (Basis: SKC Polyester Film SC 44, Rₐ=0.11 μm by test method B) (based on Hostaphan™5210) and dried at 45° C. for 48 hours. The coat weight is 2 g/m². Subsequently, coating takes place again on the same side, using the black ink. Drying takes place again at 45° C. for 48 hours. The doubly coated side is completely and uniformly black. The coat weight of both inks is 4 g/m².

### Film 3 (Black/Silver):

The black ink is applied over one side of the Al-coated film SC 42 (Basis: SKC Polyester Film SC 42, Rₐ=0.08 μm by test method B) and dried at 45° C. for 48 hours. The side coated with black coating material is completely and uniformly black. The coat weight is approximately 2 g/m².

### Reference Film 1 (Black/White):

The black ink is applied over one side of SWO83 (SKC Polyester Film 23 μm) and dried at 45° C. for 48 hours. The side coated with black paint is completely and uniformly black. The coat weight is approximately 2 g/m².

### Reference Film 2 (Black/Silver):

The black ink is applied over one side of the Al-coated film (PET film Rₐ=1.00 μm by test method B) and dried at 45° C. for 48 hours. The side coated with black paint is completely and uniformly black. The coat weight is approximately 2 g/m².

### Example 1

Film 1 is coated by lamination with polymer 1 on one side at 50 g/m².

### Example 2

Film 1 is coated by lamination with polymer 1 on both sides at 50 g/m².

### Example 3

Film 2 is coated by lamination with polymer 1 on one side at 50 g/m².

### Example 4

Film 2 is coated by lamination with polymer 1 on both sides at 50 g/m².

### Example 5

Film 3 is coated by lamination with polymer 1 on one side at 50 g/m².

### Example 6

Film 3 is coated by lamination with polymer 1 on one side at 50 g/m².

### Reference Example 1

Reference film 1 is coated by lamination with polymer 1 on both sides at 50 g/m².

### Reference Example 2

Reference film 2 is coated by lamination with polymer 1 on both sides at 50 g/m².

### Results

Examples 1 to 6 were tested by test method A along with reference examples 1 and 2.

The results are set out in table 1.

From the results from table 1 it is apparent that examples 1 to 6 and also reference examples 1 and 2 exhibit a very low transmittance of less than 0.1%. The measurements demonstrate that the composition of the coating and the metallization both allow a very low light transmission to be achieved for the adhesive tapes.

TABLE 1

| | Transmittance |
|---|---|
| Example | (Test A) |
| 1 | <0.1% |
| 2 | <0.1% |
| 3 | <0.1% |
| 4 | <0.1% |
| 5 | <0.1% |
| 6 | <0.1% |
| Reference 1 | <0.1% |
| Reference 2 | <0.1% |

To investigate the reflection behavior, optical measurements were performed from the metallized side. As a reference for this, bonding took place to glass.

The values are shown in table 2.

The results demonstrate that, as the roughness goes up, the diffuse fraction in the reflection increases significantly. At the same time, however, the reflection values are still at a very high level. Reference example 1 demonstrates that with a smooth, white film and with Rₐ values of 0.05 μm, the reflection values achievable are low.

Reference example 2, with an Rₐ value of greater than 0.35 μm, demonstrates that, at very high roughnesses, the diffuse fraction is very high (greater than 80%), but the overall reflection (total) has dropped significantly and is well below 80%. Accordingly the light yield, in the case of adhesive bonding of the backlighting unit of keyboards, is too low.

TABLE 2

| | Reflectance | | |
|---|---|---|---|
| | (scattered/diffuse | | Film roughness |
| | fraction) | Reflectance (total) | Rₐ |
| Example | (Test C) | (Test C) | (Test B) |
| 1 | 69.0% | 83.5% | 0.221 μm |
| 2 | 69.0% | 83.5% | 0.11 μm |
| 3 | 44.3% | 85.3% | 0.08 μm |
| 4 | 44.3% | 85.3% | 0.08 μm |
| 5 | 36.5% | 85.3% | 0.08 μm |
| 6 | 36.5% | 85.3% | 0.08 μm |
| Reference 1 | 65.7% | 71.2% | 0.05 μm |
| Reference 2 | 81.2% | 64.9% | 1.00 μm |

For performance trailing, examples 1, 3, 5 and 6 and also reference example 2 were attached to the back side of a backlighting keyboard. The keyboard has keys measuring 1×1 cm and has a total size of approximately 8 cm×28 cm.

When reference example 1 is used, in contrast, light spots occur during the bonding of the backlighting unit to the LC display, these spots occurring in the display and being appropriate to avoid. Using 8 LED units (each of 3 mm in diameter/8000 mcd/white/3.4 volt operating voltage/20° opening angle), the keyboard was backlit. Subsequently, the entire light yield of the keyboard was determined by the numbers and letters in the dark. Through the use of examples 1, 3, 5, and 6, it was possible to increase the light yield of the overall film keyboard by 2.5%, in contrast to reference example 2.

1. An at least single-sided pressure-sensitive adhesive tape (PSA tape) comprising at least one multilayer carrier material and at least one layer of a pressure-sensitive adhesive, said adhesive tape exhibiting a light transmittance of not more than 0.1% and a total light reflection of at least 80%, and a scattered light fraction of 30% to 80%.

2. The PSA tape of claim 1, which is a double-sided PSA tape.

3. The PSA tape of claim 1, which has a light-reflecting side and a light-absorbing side.

4. The PSA tape of claim 3, wherein the light absorption of the light-absorbing side is brought about wholly or partly by a black-colored layer of the adhesive tape.

5. The PSA tape of claim 3, wherein the light reflection of the light-reflecting side is brought about wholly or partly by a metallically reflecting layer on a part of the adhesive tape.

6. A backlit keyboard or keyboard array comprising at least one PSA tape of claim 1.

7. A method of adhering component parts of a backlit keyboard or keyboard array, said method comprising adhering said component parts with at least one PSA tape of claim 1.

8. The method of claim 7, wherein the PSA tape is a double-sided PSA tape.

9. The method of claim 7, wherein the PSA tape has a light-reflecting side and a light-absorbing side.

10. The method of claim 9, wherein the light absorption of the light-absorbing side is brought about wholly or partly by a black-colored layer of the adhesive tape.

11. The method of claim 9, wherein the light reflection of the light-reflecting side is brought about wholly or partly by a metallically reflecting layer on a part of the adhesive tape.
